(19) United States
(12) Patent Application Publication
(10) Pub. No.: US 2023/0374254 A1
(43) Pub. Date: Nov. 23, 2023

(54) Value Chain Return Process for Spent Polyamides by Hydrogenation

(71) Applicant: BASF SE, Ludwigshafen am Rhein (DE)

(72) Inventors: Thomas Schaub, Ludwigshafen (DE); Paul Neumann, Ludwigshafen (DE); Mona Al Batal, Ludwigshafen (DE); A. Stephen K. Hashmi, Heidelberg (DE); Wei Zhou, Heidelberg (DE)

(21) Appl. No.: 18/031,401

(22) PCT Filed: Oct. 12, 2021
(86) PCT No.: PCT/EP2021/078130

§ 371 Date: Apr. 12, 2023

(30) Foreign Application Priority Data
Oct. 13, 2020 (EP) 20201516.0

(51) Int. Cl. C08J 11/28

(52) U.S. Cl. CPC C08J 11/28; C08J 2377/06

(57) ABSTRACT

Spent polyamides are returned to the value chain by hydrogenating the spent polyamide in a hydrogen atmosphere in the presence of at least one homogeneous transition metal catalyst complex, wherein the transition metal is selected from metals of groups 7, 8, 9 and 10 of the periodic table of elements according to IUPAC, to obtain a polyamine and a polyol. The hydrogenation is carried out at a reaction temperature of at least 160° C. in a non-reducible solvent having a dipole moment in the range of 1·10⁻³⁰ to 10·10⁻³⁰ C·m.

The present invention relates to a value chain return process for spent polyamides, comprising their hydrogenating to obtain polyamines and polyols. The process is carried out in the presence of a homogeneous transition metal catalyst complex in selected solvents.

In the last three decades, there has been an enormous increase in worldwide plastics demand. For example, in the last 10 years, the amount of plastics produced worldwide has increased by almost 50%. Within 30 years, it has even almost quadrupled reaching an amount of 359 million metric tons in 2018. From these facts, it becomes clear that production of said huge amounts of plastics is followed by a need to dispose or recycle spent plastics. Preference should be given to recycling as thereby valuable materials, e.g. compounds which can act as monomers, can be added back to the value chain, e.g. by direct re-use in plastics production.

Thus, there is a need to develop processing techniques to recover materials from used plastics. The recycling process of spent plastics should reduce both the waste of material and the carbon footprint. Further, it should be an economical and energy efficient process delivering valuable materials which comprise high technical features. In contrast, disposal, e.g. by combustion, has a negative impact on the environment as well as on the carbon footprint.

Among the plastics mentioned above, e.g. polyamides (PA) are important representatives. Polyamides are e.g. used in applications such as clothing, fabrics, ropes, cords, strings, parachutes, balloons, sails, dowels, insulators, gears, oil pans etc.

It is known to use depolymerization processes in the treatment of waste plastics. A substantial goal of such treatments to plastic waste is chemical recycling. In such a recycle process the waste plastics are converted into constituent monomers which may be suitable for reforming original plastic. In such recycling processes, it is desirable to improve the efficiency of the depolymerization of the waste polymers into their corresponding monomers. In the case of the commercially important polyamide nylon 66, depolymerization would result in the regeneration of the monomers hexamethylene diamine and adipic acid.

Polyamides of substantially aliphatic composition, hereinafter nylon, are known to be depolymerized through acid hydrolysis. Such a depolymerization process uses an excess of sulfuric acid, which also functions effectively as the solvent for the process. In order to recover the monomeric materials, a separation or neutralization step is required from the sulfuric acid solvent in which the reaction takes place. The products of acid hydrolysis are amine salts and carboxylic acids. The disadvantages of such processes are that they give rise to the generation of significant amounts of problematic effluent streams, and they are also associated with difficulties in the separation and isolation of the target monomers.

The recycling of polyamides, e.g. polyamide 66 (nylon), to valuable monomeric compounds without salt production still remains challenging (see: Plastics recycling, in Ullmann's Encyclopedia of Industrial Chemistry, 2020, DOI: 10.1002/14356007. a21_057.pub2).

The WO 95/19950 discloses a process for the depolymerization of polyamide 66 using a Lewis Acid catalyst in a high pressure NH₃ atmosphere at 300° C. In this case, both the high reaction temperature and the restriction to access only nitrogen-containing monomeric compounds are disadvantages of the depolymerization.

Matsumoto et al., J. Mater. Cycles Waste Manag., 2017, 19, 326-331, disclose an uncatalyzed reductive depolymerization of polyamide 66 in supercritical methanol using glycolic acid at 270 to 300° C. The process yields 1,6-hexanediol (up to 52%) obtained from the polymer diamine unit and dimethyl adipate obtained from the polymer dicarboxylic acid unit. Besides the high reaction temperatures, a drawback of this approach is that no 1,6-diaminohexane is obtained.

Depolymerization of polyamide 66 by hydrogenation to obtain monomeric 1,6-diaminohexane as well as the valuable polyol 1,6-hexanediol is of high economic interest. 1,6-hexanediol may be used as a feedstock in various industrial processes, or may be converted to adipic acid and re-integrated in the value chain leading to polyamide 66.

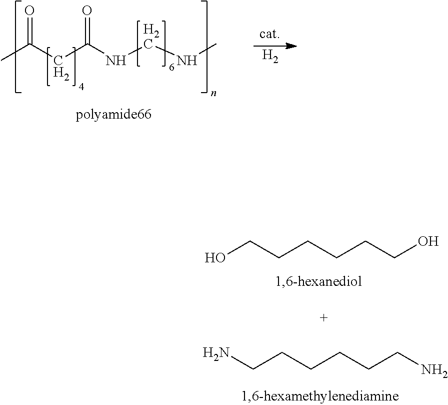

The DE 1 695 282 discloses a process for the depolymerization of polyamide 66 using a heterogeneous Ru- or Ni-containing hydrogenation catalyst in a high pressure NH₃ and H₂ atmosphere at 290° C. Drawbacks of this approach are the reaction conditions (NH₃ atmosphere and high reaction temperatures) as well as that solely the nitrogen-containing monomer is obtained.

A. Kumar et al., J. Am. Chem. Soc. 2020, 142, 14267-14275 describe the hydrogenative depolymerization of polyamides such as nylon 12, nylon 6 and nylon 66 in the presence of a homogeneous ruthenium-based catalyst with tridentate P,N,N-ligands. So far, good results were obtained at 150° C. in DMSO as a solvent. Indeed, it is claimed that DMSO as a solvent plays a critical role. It is stated that, on the other hand, “no conversion of nylon 6 was observed when toluene, tetrahydrofuran, 1,4-dioxane, water or dimethylformamide was used” (page 14268, right column).

However, said plastics recycling process has major drawbacks such as low diol and diamine yields (max. 25%) and limitation of plastics scope to low molecular weight polyamides (<3500 g/mol). Also, the use of the polar, unsaturated solvent DMSO is a drawback, as under the hydrogenation conditions dimethylsulfide can be formed as a side product by hydrogenation of DMSO. Further, separation of DMSO from the products is difficult due to its high boiling point and DMSO is prone to decomposition at the elevated reaction temperatures (see: Org. Process Res. Dev. 2020, 24, 1614-1620).

Therefore, it is the object of the present invention to provide an environmentally friendly and economically advantageous catalytic hydrogenation reaction for hydrogenating spent polyamides to obtain polyamines and polyols.

This object has been achieved by a value chain return process for spent polyamides. The process comprises hydrogenating the spent polyamides in a hydrogen atmosphere in the presence of at least one homogeneous transition metal catalyst complex, wherein the transition metal is selected from metals of groups 7, 8, 9 and 10 of the periodic table of elements according to IUPAC, to obtain a polyamine and a polyol, characterized in that the hydrogenation is carried out at a reaction temperature of at least 160° C. in a non-reducible solvent having a dipole moment in the range of 1·10⁻³⁰ to 10·10⁻³⁰ C·m.

“Value chain return” is intended to mean that the low molecular products obtained by the process of the invention can be re-integrated in a value chain leading to polyamides or else be used as feedstocks in an other value chain.

A solvent suitable for the hydrogenation of polyamides must have certain properties, including the ability to dissolve the polyamides used as starting materials, chemical inertness under the hydrogenation conditions, and electronic properties allowing hydrogenation of the polyamides.

According to the invention, the hydrogenation is carried out in a non-reducible solvent having a dipole moment in the range of 1·10⁻³⁰ to 10·10⁻³⁰ C·m.

The term “non-reducible” means that the solvent is not capable of reacting with hydrogen at the reaction conditions applied, e.g. at the temperature and pressure at which the process is operated. That is, non-reducible solvents do not contain C═O, C═S, C═N or non-aromatic C═C bonds.

The solvent has a dipole moment in the range of 1·10⁻³⁰ to 10·10⁻³⁰ C·m, measured at a temperature 298 K. Preferably, the solvent has a dipole moment in the range of 1.5·10⁻³⁰ to 8·10⁻³⁰ C·m, more preferred in the range of 2·10⁻³⁰ to 6·10⁻³⁰ C·m. The dipole moment of a solvent is a relative measure of its chemical polarity. High dipole moment values correlate to polar solvents. Reference values for dipole moment of commonly used solvents may be obtained, e.g., from Handbook of Chemistry and Physics, CRC Press, Boca Raton, Florida, 91st Edition, 2010.

It is contemplated that the solubility of polyamides is higher in more polar solvents. However, highly polar solvents have drawbacks as discussed above. Therefore, the present selection of solvents having a medium polarity, i.e. dipole moment values from 1·10⁻³⁰ to 10·10⁻³⁰ C·m, is a trade-off between a suitable polarity, which dissolve the polyamides at least to the extent that they are accessible for hydrogenation, while avoiding the drawbacks of highly polar solvents.

In a preferred embodiment, the solvent comprises at least one electron pair donor. The “electron pair donor” provides nucleophilicity to the solvent and thereby facilitates activation of the bonds to be hydrogenated. The solvent comprises functional groups that act as electron pair donor. Suitable electron pair donors include atoms such as nitrogen or oxygen, e.g., bound as amino group, hydroxyl group or ether moieties. Generally, non-protic solvents are preferred.

In one embodiment, the non-reducible solvent is selected from ethers, alcohols and amines.

Suitable ethers (dipole moment values in brackets) are selected from tetrahydrofuran (5.84·10⁻³⁰ C·m), 1,4-dioxane (1.50·10⁻³⁰ C·m), anisole (4.17·10⁻³⁰ C·m), diethyl ether (4.34·10⁻³⁰ C·m), diisopropyl ether (4.34·10⁻³⁰ C·m), dibutyl ether (3.90·10⁻³⁰ C·m), methyl tert-butyl ether (4.40·10⁻³⁰ C·m), and diethylene glycol dimethyl ether (5.70·10⁻³⁰ C·m).

Suitable alcohols are selected from methanol (5.67·10⁻³⁰ C·m), ethanol (5.77·10⁻³⁰ C·m), n-propanol (5.54·10⁻³⁰ C·m), isopropanol (5.54·10⁻³⁰ C·m), tert-butanol (5.54·10⁻³⁰ C·m), trifluorethanol (6.77·10⁻³⁰ C·m), ethyleneglycol (7.61·10⁻³⁰ C·m), and 1,3-propandiol (8.41·10⁻³⁰ C·m).

Suitable amines are selected from 1-butylamine (3.34·10⁻³⁰ C·m), triethylamine (2.90·10⁻³⁰ C·m), ethylenediamine (6.64·10⁻³⁰ C·m), morpholine (4.94·10⁻³⁰ C·m), piperidine (3.97·10⁻³⁰ C·m), and aniline (5.04·10⁻³⁰ C·m).

If desired, mixtures of two or more of the afore-mentioned solvents may be used.

In a preferred embodiment, the non-reducible solvent is selected from tetrahydrofuran, 1,4-dioxane or anisole. Tetrahydrofuran is particularly preferred.

In one embodiment, the hydrogenation reaction is carried out in the essential absence of DMSO. More preferably, the hydrogenation reaction is carried out in the absence of a solvent other than solvents defined above, i.e. in the absence of solvents that are reducible under the conditions of the process and/or having a dipole moment of less than 1·10⁻³⁰ C·m or more than 10·10⁻³⁰ C·m.

While the net energy balance of the hydrogenation reaction is exothermal, the initiation requires supply of energy (activation energy). Higher temperatures also facilitate solubilization of the polyamide by the solvents defined above to make the polyamide accessible for hydrogenation. To provide the required activation energy and to solubilize sufficient amounts of polyamide, the hydrogenation reaction is carried out at elevated reaction temperatures of at least 160° C. In one embodiment, the reaction temperature is from 170 to 220° C., preferably from 180 to 210° C.

The hydrogenation is carried out in a hydrogen atmosphere. This is because molecular hydrogen is consumed during the hydrogenation reaction of polyamides. Hydrogen pressure has an influence on the outcome of the reaction. Lower pressures typically result in a slower rate of reaction, whereas higher pressures result in a faster rate of reaction. Thus, the hydrogen atmosphere is suitably present at elevated pressure levels. Hence, the hydrogenation reaction occurs in a pressurized reaction vessel, e.g. an autoclave. In one embodiment, the hydrogenation reaction is carried out at a pressure of 50 to 500 bar absolute, preferably 60 to 300 bar absolute, more preferably 80 to 200 bar absolute.

The hydrogenation reaction is carried out in the presence of at least one homogeneous transition metal catalyst complex (hereinafter also referred to as “hydrogenation catalyst”), comprising at least one polydentate ligand having at least one nitrogen atom and at least one phosphorous atom which are capable of coordinating to the transition metal.

Generally, the amount of the hydrogenation catalyst present in the hydrogenation reaction may be varied in a wide range. Suitably, the hydrogenation catalyst is present in the hydrogenation reaction in an amount of 0.1 to 5000 ppm (parts per weight calculated as catalyst metal), preferably 1 to 2000 ppm, more preferably 50 to 1000 ppm.

The hydrogenation catalyst comprises a transition metal selected from metals of groups 7, 8, 9 and 10, preferably of groups 8, 9 and 10 of the periodic table of elements according to IUPAC.

In one embodiment, the homogeneous transition metal catalyst complex comprises a transition metal selected from iron, cobalt, rhodium, osmium, rhenium, ruthenium, iridium, nickel, palladium and platinum, preferably ruthenium.

Generally, the homogeneous transition metal catalyst complex comprises at least one ligand in order to solubilize the transition metal in the reaction solution and to maintain the transition metal in an active form for hydrogenation. Preferred ligands are polydentate ligands having at least one nitrogen atom and at least one phosphorous atom which are capable of coordinating to the transition metal.

The hydrogenation catalyst may further comprise one or more additional ligands, such as an anion selected from the group consisting of hydride, alkoxides, aryloxides, carboxylates and acyl, or a neutral ligand selected from the group consisting of carbon monoxide, triaryl phosphines, amines, N-heterocyclic carbenes and isonitriles. Preferably, the hydrogenation catalyst further comprises a carbon monoxide ligand, a halide or a hydride.

In one embodiment, the at least one polydentate ligand conforms to general formula (I)

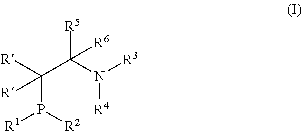

in which
each R′ is independently H or C₁-C₄-alkyl,
R¹ and R², independently of one another, are C₁-C₁₂-alkyl, cycloalkyl or aryl, which alkyl is unsubstituted or carries 1, 2, 3, 4 or 5 identical or different substituents R⁷, and
   which cycloalkyl and aryl are unsubstituted or carry 1, 2, 3, 4 or 5 identical or different substituents R⁸,
R³ and R⁴, independently of one another, are H or C₁-C₁₂-alkyl, which is unsubstituted or carries 1, 2, 3, 4 or 5 identical or different substituents selected from alkoxy, cycloalkoxy, heterocycloalkoxy, aryloxy, hetaryloxy, hydroxyl, NE¹E² and PR¹R²,
R⁵ is H or C₁-C₁₂-alkyl, which is unsubstituted or carries 1, 2, 3, 4 or 5 identical or different substituents R⁷,
R⁶ is H or C₁-C₄-alkyl,
or
R⁴ and R⁶ are absent and R³ and R⁵, together with the nitrogen atom to which R³ is bonded and the carbon atom to which R⁵ is bonded, form a 6-membered heteroaromatic ring,
   which is unsubstituted or carries 1, 2, 3, 4 or 5 identical or different substituents which are selected from C₁-C₁₂-alkyl, cycloalkyl, aryl and hetaryl,
   which alkyl is unsubstituted or carries 1, 2, 3, 4 or 5 identical or different substituents R⁷, and
   which cycloalkyl, aryl and hetaryl are unsubstituted or carry an alkyl substituent which is unsubstituted or carries a substituent selected from alkoxy, cycloalkoxy, heterocycloalkoxy, aryloxy, hetaryloxy, hydroxyl, NE¹E² and PR¹R²,
each R⁷ is independently cycloalkyl, heterocycloalkyl, aryl, hetaryl, alkoxy, cycloalkoxy, heterocycloalkoxy, aryloxy, hetaryloxy, hydroxyl or NE¹E²,
each R⁸ is independently C₁-C₄-alkyl, cycloalkyl, heterocycloalkyl, aryl, hetaryl, alkoxy, cycloalkoxy, heterocycloalkoxy, aryloxy, hetaryloxy, hydroxyl or NE¹E², and
E¹ and E², independently of one another and independently of each occurrence, are radicals selected from H, C₁-C₁₂-alkyl, cycloalkyl and aryl.

The term “cycloalkyl” (also in combinations such as “cycloalkyloxy”) indicates a saturated cyclic aliphatic hydrocarbon radical having 3 to 8 carbon atoms, preferably 4 to 7 carbon atoms, more preferably 5 to 6 carbon atoms. Preference is given to cyclopentyl or cyclohexyl.

The term “heterocycloalkyl” (also in combinations such as “heterocycloalkoxy”) indicates a saturated 3 to 8 membered cyclic hydrocarbon radical, wherein one or more carbon atoms have been replaced by heteroatoms selected from O, S, N and P, or combinations thereof. Preference is given to pyrrolidinyl, imidazolidinyl, pyrazolidinyl, piperidyl, piperazinyl, morpholinyl, tetrahydrofuranyl, tetrahydropyranyl, tetrahydrothiophene and the like, and also methyl-, ethyl-, propyl-, isopropyl- and tert-butyl-substituted derivatives thereof.

The term “aryl” (also in combinations such as aryloxy) indicates monocyclic or annelated aromatic carbocycles, preferably phenyl or naphthyl radicals, more preferably phenyl radicals.

The term “hetaryl” (also in combinations such as hetaryloxy) indicates a 3 to 8 membered aromatic carbocycle, wherein one or more carbon atoms have been replaced by heteroatoms selected from O, S, N and P, or combinations thereof, and which may be annelated with 1 or 2 aromatic cycles. Preference is given to furyl, thienyl, pyrrolyl, pyridyl, pyrazolyl, imidazolyl, oxazolyl, thiazolyl, pyrimidinyl, pyrazinyl and the like, and also methyl-, ethyl-, propyl-, isopropyl- and tert-butyl-substituted derivatives thereof.

Most preferably, hetaryl is pyridyl.

Preferably, R′ is H.

Preferably, R¹ and R² are identical and are selected from the group consisting of isopropyl, cyclohexyl, tert-butyl, and phenyl.

Preferably, R³ is H or C₁-C₃-alkyl.

Preferably, R⁴ is H or —(CH₂)₂—PR¹R², e.g., —(CH₂)₂—PPh₂.

Preferably, R⁵ is H or C₁-C₃-alkyl.

Preferably, R⁶ is H.

In a further preferred embodiment, R⁶ and R⁴ are absent and R³ and R⁵, together with the nitrogen atom to which R³ is bonded and the carbon atom to which R⁵ is bonded, form a 6-membered heteroaromatic ring. Preferably, the 6-membered heteroaromatic ring carries one substituent, preferably in the 6-position, assuming that the heteroatom is in the 1-position and —CR′R′—PR¹R² is in the 2-position.

In one embodiment, the at least one polydentate ligand conforms to general formula (II)

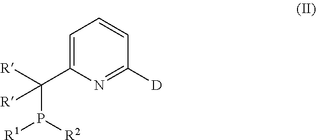

in which
D is H, C₁-C₁₂-alkyl, cycloalkyl, aryl or hetaryl,
which alkyl is unsubstituted or carries 1, 2, 3, 4 or 5 identical or different substituents R⁷, and
which cycloalkyl, aryl or hetaryl are unsubstituted or carry an alkyl substituent which is unsubstituted or carries a substituent selected from alkoxy, cycloalkoxy, heterocycloalkoxy, aryloxy, hetaryloxy, hydroxyl, NE¹E² and PR¹R², preferably NE¹E² and PR¹R².

In a preferred embodiment, D is C₁-C₁₂-alkyl substituted by NE¹E²; hetaryl which is unsubstituted; or hetaryl which carries a C₁-C₁₂-alkyl substituted by NE¹E² or PR¹R².

In a more preferred embodiment, D is a methyl group substituted by NE¹E²; 2-pyridyl which is unsubstituted; or 2-pyridyl which is substituted in 6-position by —CH₂—NE¹E² or —CH₂—PR¹R².

In one embodiment, the at least one polydentate ligand is selected from compounds A to G,

wherein Et is ethyl, ⁱPr is isopropyl, ^{t}Bu is tert-butyl, Cy is cyclohexyl, Ph is phenyl:

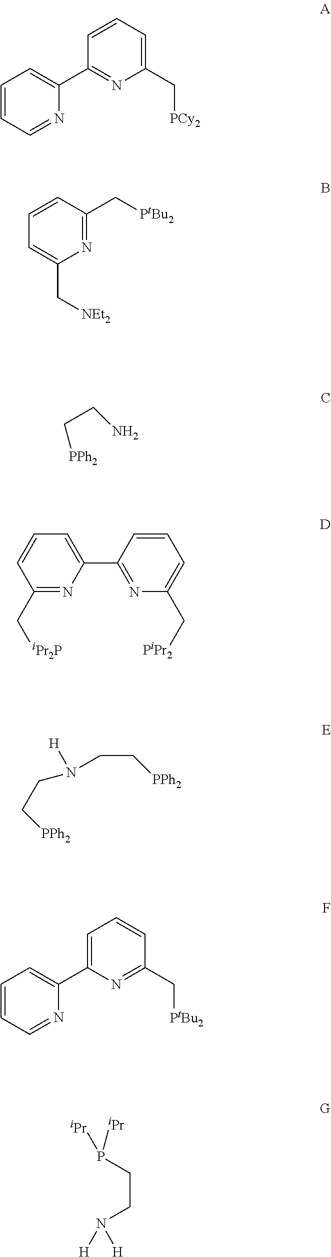

Homogeneous, e.g. ruthenium-based, hydrogenation catalyst complexes have been known per se. Such catalyst complexes allow for catalytically active ruthenium in an effective environment for hydrogenations. For this purpose, various ligand systems have been studied; for example, BINAP- (Noyori), P,N,N- (Milstein) or P,N,P-ligands (Takasago) have been used successfully in hydrogenation reactions.

In a preferred embodiment, the transition metal is ruthenium and the polydentate ligand conforms to one of compounds A to G.

The hydrogenation catalyst may be employed in the form of a preformed metal complex, which comprises the metal compound and one or more ligands.

In a preferred embodiment, the hydrogenation catalyst is a pre-formed ruthenium-catalyst, selected from compounds H to Q,

wherein Et is ethyl, ⁱPr is isopropyl, ^{t}Bu is tert-butyl, Cy is cyclohexyl, Ph is phenyl:

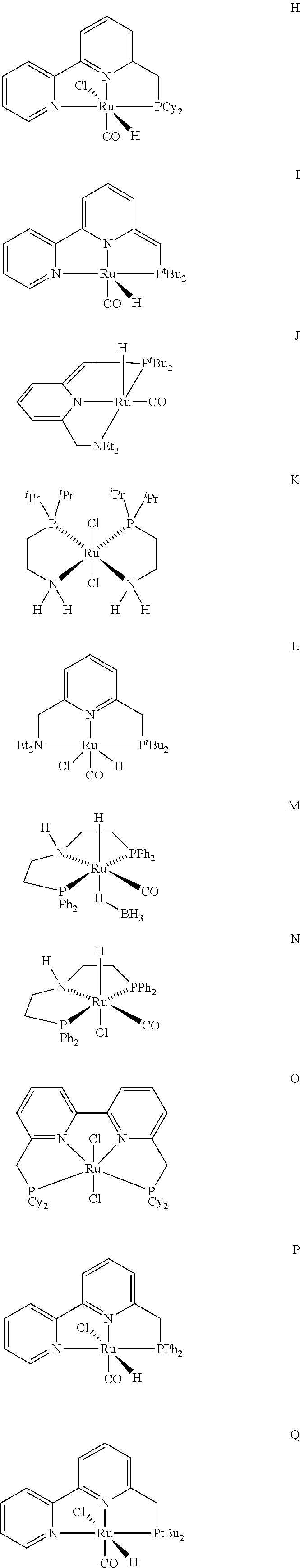

No special or unusual techniques are needed for preparing the catalyst used in the present invention. However, in order to obtain a catalyst of high activity, it is preferred to carry out the manipulations under an inert atmosphere, e.g., nitrogen, argon and the like.

Alternatively, the hydrogenation catalyst is formed in situ in the reaction mixture by combining a metal compound, hereinafter also referred to as “pre-catalyst”, and at least one suitable ligand to form a catalytically active metal complex in the reaction medium (“hydrogenation catalyst”). It is also possible that the hydrogenation catalyst is formed in situ in the presence of an auxiliary ligand by combining a metal compound and at least one auxiliary ligand to form a catalytically active metal complex in the reaction medium.

Suitable pre-catalysts are selected from neutral metal complexes, oxides and salts of the transition metals. Preferred pre-catalysts are selected from metal complexes, oxides and salts of rhenium, ruthenium, iridium, nickel, palladium and platinum, more preferably ruthenium.

In the context of this application, “COD” denotes 1,5-cyclooctadiene, “Cp” denotes cyclopentadienyl, “Cp*” denotes pentamethylcycopentadienyl and “binap” denotes 2,2′-bis(diphenylphosphino)-1,1′-binaphthyl.

Suitable rhenium pre-catalysts are selected from ammoniumperrhenate, chlorotricarbonyl(2,2′-bipyridine)rhenium(I), chlorotricarbonyl(4,4′-di-t-butyl-2,2′-bi-pyridine)rhenium(I), cyclopentadienylrhenium tricarbonyl, iododioxobis(triphenyl-phosphine)rhenium(V), methyltrioxorhenium(VII), pentamethylcyclopentadienylrhenium tricarbonyl, rhenium carbonyl, rhenium(V) chloride, rhenium pentacarbonyl bromide, and trifluoromethylsulfonatotricarbonyl(2,2′-bipyridine)rhenium(I).

Suitable ruthenium pre-catalysts are selected from [Ru(methylallyl)₂COD], [Ru(p-cymene)Cl₂]₂, [Ru(benzene)Cl₂]ₙ, [Ru(CO)₂Cl₂]ₙ, [Ru(CO)₃Cl₂]₂, [Ru(COD)(allyl)], [RuCl₃·H₂O], [Ru(acetylacetonate)₃], [Ru(DMSO)₄Cl₂], [Ru(PPh₃)₃(CO)(H)Cl], [Ru(PPh₃)₃(CO)Cl₂], [Ru(PPh₃)₃(CO)(H)₂], [Ru(PPh₃)₃Cl₂], [Ru(Cp)(PPh₃)₂Cl], [Ru(Cp)(CO)₂Cl], [Ru(Cp)(CO)₂H], [Ru(Cp)(CO)₂]₂, [Ru(Cp*)(CO)₂Cl], [Ru(Cp*)(CO)₂H], [Ru(Cp*)(CO)₂]₂, [Ru(indenyl)(CO)₂Cl], [Ru(indenyl)(CO)₂H], [Ru(indenyl)(CO)₂]₂, ruthenocen, [Ru(binap)(Cl)₂], [Ru(2,2′-bipyridin)₂(Cl)₂—H₂O], [Ru(COD)(Cl)₂H]₂, [Ru(Cp*)(COD)Cl], [Ru₃(CO)₁₂], [Ru(tetraphenylhydroxycyclopentadienyl)(CO)₂H], [Ru(PMe₃)₄(H)₂], [Ru(PEt₃)₄(H)₂], [Ru(Pn-Pr₃)₄(H)₂], [Ru(Pn-Bu₃)₄(H)₂], and [Ru(Pn-octyl₃)₄(H)₂], preferably [Ru(methylallyl)₂COD], [Ru(COD)Cl₂]₂, [Ru(Pn-Bu₃)₄(H)₂], [Ru(Pn-octyl₃)₄(H)₂], [Ru(PPh₃)₃(CO)(H)Cl] and [Ru(PPh₃)₃(CO)(H)₂], more preferably [Ru(PPh₃)₃(CO)(H)Cl].

Suitable iridium pre-catalysts are selected from [IrCl₃·H₂O], KIrCl₄, K₃IrCl₆, [Ir(COD)Cl]₂, [Ir(cyclooctene)₂Cl]₂, [Ir(ethene)₂Cl]₂, [Ir(Cp)Cl₂]₂, [Ir(Cp*)Cl₂]₂, [Ir(Cp)(CO)₂], [Ir(Cp*)(CO)₂], [Ir(PPh₃)₂(CO)Cl], and [Ir(PPh₃)₃Cl], preferably [Ir(COD)Cl]₂, [Ir(cyclo-octene)₂Cl]₂, and [Ir(Cp*)Cl₂]₂.

Suitable nickel pre-catalysts are selected from [Ni(COD)₂], Ni(CO)₄, NiCl₂, NiBr₂, NiI₂, Ni(OAc)₂ [Ni(AcAc)₂], [Ni(Cl)₂(TMEDA)], [Ni(Cl)₂(DME)], [Ni(Br)₂(DME)], [Ni(Cl)₂(PPh₃)₂], [Ni(CO)₂(PPh₃)], [Ni(Cl)(methallyl)]₂, [Ni(CO₃)], nickel(II)diemthylglyoxime, nickel(II)2-ethylhexanoate, nickel(II)hexafluroacetlyacetonate, bis(N,N′-di-t-butyl-acetamidinato)nickel(II), nickel(II)oxalate, Ni(NO₃)₂, nickel(II)stearate, Ni(SO₄), nickel(II)tetrafluoroborate hexahydrate, nickel(II)trifluoroaceylacetonate dehydrate, and nickel(II)trifluoromethanesulfonate.

Suitable palladium pre-catalysts are selected from allyl(cyclopentadienyl)palladium(II), bis[(trimethylsilyl)methyl](1,5-cyclooctadiene)palladium(II), allylpalladium chloride dimer, ammonium tetrachloropalladate(II), bis[1,2-bis(diphenylphosphino)ethane]palladium(0), bis(dibenzylideneacetone)palladium(0), trans-bis(dicyclohexylamine)bis(acetato)-palladium(II), bis(2-methylallyl)palladium chloride dimer, bis(tri-t-butylphosphine)-palladium(0), bis(tricyclohexylphosphine)palladium(0), bis(tri-o-tolylphosphine)-palladium(0), chloromethyl(1,5-cyclooctadiene)palladium(II), diacetato[1,3-bis(diphenyl-phosphino)propane]palladium(II), diacetatobis(triphenylphosphine)palladium(II), diacetato(1,10-phenanthroline)palladium(II), di-μ-bromobis(tri-t-butylphosphino)-dipalladium(I), trans-dibromobis(triphenylphosphine)palladium(II), dibromo(1,5-cyclo-octadiene)palladium(II), dichlorobis(benzonitrile)palladium(II), dichlorobis(di-t-butyl-phenylphosphino)palladium(II), di-μ-chlorobis{2-[(dimethylamino)methyl]phenyl}dipalladium, trans-dichlorobis(tricyclohexylphosphine)palladium(II), trans-dichlorobis(tri-phenylphosphine)palladium(II), dichloro(1,5-cyclooctadiene)palladium(II), dichloro(nor-bornadiene)palladium(II), cis-dichloro(N,N,N′,N′-tetramethylethylenedi-amine)palladium(II), cis-dimethyl(N,N,N′,N′-tetramethylethylenediamine)palladium(II), (1-methylallyl)palladium chloride dimer, palladium(II) acetate, palladium(II) acetylacetonate, palladium(II) benzoate, palladium(II) bromide, palladium(II) chloride, palladium(II) hexafluoroacetylacetonate, palladium(II) iodide, palladium(II) sulfate, palladium(II) trifluoroacetate, palladium(II) trimethylacetate, tetrakis(triphenyl-phosphine)palladium(0), and tris(dibenzylideneacetone)dipalladium(0).

Suitable platinum pre-catalysts are selected from ammonium tetrachloroplatinate(II), bis(tri-t-butylphosphine)platinum (0), bis(ethylenediamine)platinum(II) chloride, dibromo(1,5-cyclooctadiene)platinum(II), dichlorobis(benzonitrile)platinum(II), cis-dichlorobis(diethylsulfide)platinum(II), cis-dichlorobis(pyridine)platinum(II), cis-dichlorobis(triethylphosphine)platinum(II), dichloro(1,5-cyclooctadiene)platinum(II), cis-dichlorodiammine platinum(II), di-μ-chloro-dichlorobis(ethylene)diplatinum(II), dichloro(dicyclopentadienyl)platinum(II), di-μ-iodobis(ethylenediamine)diplatinum(II) nitrate, diiodo(1,5-cyclooctadiene)platinum(II), dimethyl(1,5-cyclooctadiene)platinum(II), platinum(II) acetylacetonate, platinum(II) acetylacetonate, platinum(II) bromide, platinum(II) chloride, platinum(II) iodide, potassium bis(oxalato)platinate(II) dihydrate, tetrakis(triphenylphosphine)platinum(0), and tris(dibenzylideneacetone)diplatinum(0).

The abovementioned hydrogenation catalyst, which comprises the polydentate ligand conforming to general formula (I), may be used in the hydrogenation reaction without the need of additional bases. However, usually, higher activities are obtained by combining catalytic amounts of a base with the hydrogenation catalyst.

In one embodiment, the hydrogenation reaction is carried out in the presence of a base, preferably an alkali metal or alkaline earth metal carbonate, an alkali metal or alkaline earth metal hydroxide or an alkali metal or alkaline earth metal alcoholate. Preferably, the base is an alkali metal alcoholate such as potassium tert-butoxide.

Generally, the base is present in the hydrogenation reaction in the range of the amount of hydrogenation catalyst used. Suitably, the base is present in an amount of 1 to 50 equivalents, preferably 1 to 10 equivalents, more preferably 1 to 4 equivalents, based on the amount of hydrogenation catalyst.

The inventive process for hydrogenating spent polyamides may be carried out in customary devices and/or reactors known to the person skilled in the art for liquid-gas reactions in which the hydrogenation catalyst is present in the liquid phase. For the inventive process, it is in principle possible to use any reactor which is fundamentally suitable for gas-liquid reactions at the stated temperatures and the stated pressures. For suitable standard reactors for gas-liquid and for liquid-liquid reaction systems, see e.g.: Reactor Types and Their Industrial Applications and Reactors for gas-liquid reactions, in Ullmann's Encyclopedia of Industrial Chemistry, 2005, Wiley-VCH Verlag GmbH & Co. KGaA, chapter 3.3. Suitable examples include, e.g., stirred tank reactors, tubular reactors or bubble column reactors. The supply of polyamide, hydrogenation catalyst, solvent and base may take place simultaneously or separately from one another. The reaction may be carried out discontinuously in batch mode or continuously, semi-continuously with recycle or without recycle. The average residence time in the reaction space may be varied in a wide range, preferably in the range from 15 minutes to 100 h, more preferably in the range from 1 to 50 h.

In particular, the invention involves spent polyamides as starting materials. In this context, the term “spent polyamide” denotes an item produced from polyamide at a time when it has already been used for the purpose for which it was manufactured.

Generally, homopolymeric polyamides are produced either by ring-opening polymerization reactions (e.g. using cyclic amids such as caprolactams as monomers) or by polycondensation reactions (e.g. using α,ω-aminocarboxylic acids; or diamines together with dicarboxylic acids as monomers). For example, an industrially important representative for a polyamide produced by polycondensation of a diamine and a dicarboxylic acid is polyamide 66 (nylon).

The present method enables re-utilization of both starting material components which are either recovered directly (polyamine) or obtained as valuable synthesis building blocks such as polyols which may readily be converted to polyurethanes, polyesters or which can be reoxidized to the dicarboxylic acid for the synthesis of polyamides.

In one embodiment, the spent polyamide is polyamide 66.

Polyamides, e.g. polyamide 66 (nylon), are technical polymers produced on a large scale (see: Polyamides, Ullmann's Encyclopedia of Industrial Chemistry, 2013, DOI: 10·1002/14356007.a21_179.pub3). Generally, it is produced by a reaction of 1,6-diaminohexane and adipic acid and conforms to the following general formula:

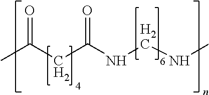

The spent polyamides used in the present invention are obtained from items produced from polyamide at a time after use for the purpose for which they were manufactured. Before subjecting to hydrogenation, the items may be subjected to mechanical comminution. That is, further sorting and bringing the items into appropriate sizes, e.g., by shredding, sieving or separation by rates of density, i.e. by air, a liquid or magnetically. Optionally, these fragments may then undergo processes to eliminate impurities, e.g. paper labels.

Generally, the solvent is employed in an amount sufficient to swell or partially dissolve the polyamide. As the hydrogenation reaction progresses, the polyamide gradually dissolves in the reaction solution. Suitably, the ratio of solvent and spent polyamides is in the range of 0.1 to 100 L solvent per 1 kg polyamide, preferably 1 to 20 L solvent per 1 kg.

The work-up of the reaction mixture obtained after hydrogenation, in particular the isolation of polyamines and polyols can be realized case dependent, for example by filtration, or distillation under reduced pressure. Preferably, the work up comprises several steps. For example, volatile compounds such as amines or diols can be separated by distillation. Thereby, the hydrogenation catalyst remains in the distillation-residue to allow recycling. The catalyst, once separated from the product, can be returned to the reactor for re-use. Alternatively, the catalyst solution can be diluted with a solvent and re-used. It is understood that the separation process described above can be combined with any of the various embodiments of the inventive process described herein.

### EXAMPLES

The present invention can be further explained and illustrated on the basis of the following examples. However, it will be understood that these examples are included merely for purposes of illustration and are not intended to limit the scope of the invention in any way.

All chemicals and solvents were purchased from Sigma-Aldrich or ABCR and used without further purification, unless otherwise specified. ¹H-, ¹³C- and ³¹P NMR spectra were recorded on Bruker Avance 200 or 400 MHz spectrometer and were referenced to the residual proton (¹H) or carbon (¹³C) resonance peaks of the solvent. Chemical shifts (δ) are reported in ppm. ³¹P NMR spectra were referred to an external standard (ample of D₃PO₄).

Hydrogenation catalysts P and Q were prepared according literature protocols: E. Balaraman, J. Am. Chem. Soc. 2010, 132, 16756-16758 and D. Srimani, Adv. Synth. Catal. 2013, 355, 2525-2530.

### Reference Example 1: Synthesis of Hydrogenation Catalyst H

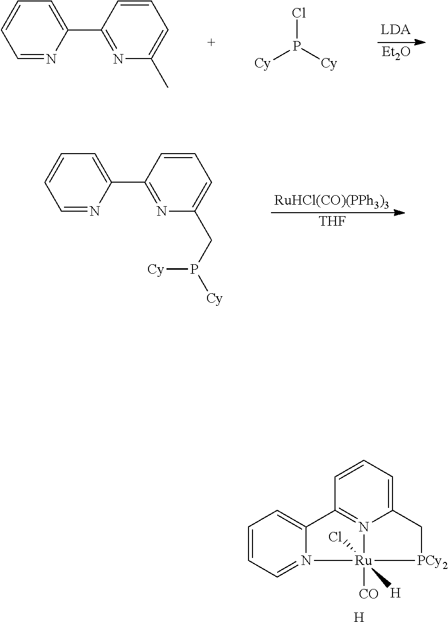

First step: In a 50 mL Schlenk tube, 6-methyl-2,2′-bipyridine (511 mg, 3.00 mmol) was dissolved in 15 mL Et₂O, cooled to 0° C. and LDA (3.50 mL, 1 M in THE/hexanes) was added dropwise. After stirring at 0° C. for 1 h, the system was cooled to −80° C. by iPrOH/liquid N₂ and CIPCy₂ (815 g, 3.50 mmol) in 5 mL Et₂O was added slowly. The cooling bath was removed after 1 h and the mixture was recovered to r.t. gradually and stirred overnight. The reaction mixture was quenched by adding 10 mL of degassed water to the yellow slurry. The organic phase was separated and the aqueous phase was extracted with ether (2×5 mL). The combined organic phase was dried over Na₂SO₄, filtered and the solvent was removed to give the crude ligand as a sticky orange oil. 52% purity based on ³¹P NMR. It was used directly for the next step without further purification.

Second step: The ligand obtained in the first step was dissolved in 20 mL THF. RuHCl(CO)(PPh₃)₃ (952 mg, 1.00 mmol) was added, the mixture was stirred at 70° C. for 5 hours and then cooled to r.t. The solvent was reduced to ca. 10 mL under vacuum and 20 mL of Et₂O were added to the remaining red-orange dispersion. The solution was removed via cannula and the solid was washed with Et₂O (2×10 mL) and dried under vacuum to give 465.2 mg of the orange product (87% yield based on Ru).

³¹P {¹H} NMR (122 MHz, CD₂Cl₂) δ 83.68.

¹H NMR (301 MHz, CD₂Cl₂) δ 9.22-9.13 (m, 1H), 8.07-7.97 (m, 1H), 7.93 (d, J=8.0 Hz, 1H), 7.86 (td, J=8.0, 1.6 Hz, 1H), 7.82 (td, J=8.0, 0.9 Hz, 1H), 7.49 (d, J=7.7 Hz, 1H), 7.45-7.39 (m, 1H), 3.82-3.56 (m, 2H), 2.46-2.27 (m, 2H), 2.08-0.99 (m, 20H), −14.83 (d, J=23.6 Hz, 1H).

¹³C {¹H} NMR (126 MHz, CD₂Cl₂) δ 207.71 (d, J=14.9 Hz), 161.70 (d, J=5.1 Hz), 156.38, 154.78 (d, J=2.7 Hz), 153.51 (d, J=1.7 Hz), 137.30, 136.51, 126.42 (d, J=1.9 Hz), 123.13 (d, J=9.6 Hz), 122.76 (d, J=1.6 Hz), 119.73, 40.59 (d, J=22.2 Hz), 38.59 (d, J=23.4 Hz), 35.76 (d, J=28.9 Hz), 31.01 (d, J=2.9 Hz), 29.60 (d, J=4.2 Hz), 28.61 (d, J=4.5 Hz), 28.20 (d, J=13.6 Hz), 27.73, 27.56 (d, J=9.2 Hz), 26.82 (d, J=4.4 Hz), 26.74 (d, J=3.5 Hz), 26.71 (d, J=2.0 Hz), 26.35 (d, J=1.5 Hz).

HRMS (ESI): m/z calcd. for C₂₄H₃₂N₂OPRu [M-Cl]⁺: 497.1296, found: 497.1291.

### Example 1: Hydrogenation of a Polyamide Sample

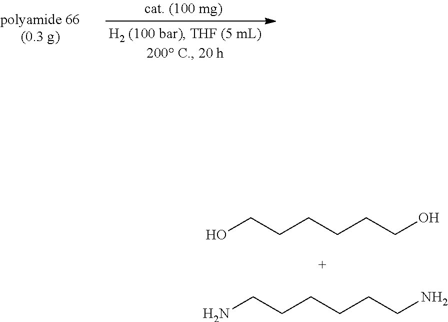 [SMILES: OCCCCCCO ; NCCCCCCN]

Under argon, a 60 mL Premex autoclave equipped with a Teflon insert was charged with 0.3 g (1.25 mmol calculated as the repeating unit) polyamide 66 (obtained by reacting adipic acid and a 15% excess of 1,6-hexamethylenediamine; MW=8240 g/mol; amino end group content=1748 mmol/kg; acid end group content=14 mmol/kg). The ruthenium complex as indicated in table 1 (0.01 mmol), KO^{t}Bu and solvent were added as shown above. The autoclave was closed, charged with H₂ to the pressure given in table 1 outside the glovebox and put in an aluminum block (preheated to the reaction temperature as shown in table 1). After the reaction was finished (20 h), the autoclave was taken out of the heating block and cooled to r.t. in a water bath. The internal pressure was carefully released. The autoclave was opened and mesitylene was added to the mixture as internal standard for GC analysis. The amounts of diamine and diol were obtained according to calibrated GC results, see table 1.

TABLE 1

| | T | p (H₂) | diamine | diamine | diol | diol | | |
|---|---|---|---|---|---|---|---|---|
| solvent | [° C.] | [bar] | [mmol] | [yield] | [mmol] | [yield] | TON ^{[a]} | catalyst |
| THF | 200 | 100 | 0.98 | 78% | 0.78 | 62% | 98 | H |
| THF | 180 | 100 | 0.75 | 60% | 0.44 | 35% | 75 | H |
| THF* | 150 | 70 | 0.15 | 12% | <0.06 | <5% | 15 | H |
| THF | 200 | 80 | 0.88 | 70% | 0.59 | 47% | 88 | H |
| dimethoxy- | 200 | 100 | 0.88 | 70% | 0.58 | 46% | 88 | H |
| ethane | | | | | | | | |
| toluene | 200 | 100 | 0.74 | 59% | 0.40 | 32% | 74 | H |
| anisole | 200 | 100 | 0.86 | 69% | 0.58 | 49% | 86 | H |

*comparative example.
^{[a]} turn-over-number = moles of diamine per mole of catalyst.

The results in table 1 show that the diol and diamine yields increase with an increase of the reaction temperature. Higher yields are obtained in solvent THE in comparison to anisole.

### Example 2: Hydrogenation of a Polyamide Sample

Under argon, a 60 mL Premex autoclave equipped with a Teflon insert was charged with 0.5 g (2.08 mmol according to the repeating unit) polyamide 66 (Ultramide A27 obtainable from BASF SE; 1:1 polyamide from adipic acid and 1,6-hexamethylenediamine). Ruthenium complex H (0.01 mmol), KO^{t}Bu (0.04 mmol) and THE (5 mL) were added. The autoclave was closed, charged with H₂ (100 bar absolute) outside the glovebox and put in an aluminum block (preheated to the reaction temperature of 200° C.). After the reaction was finished (20 h), the autoclave was taken out of the heating block and cooled to r.t. in a water bath. The internal pressure was carefully released. The autoclave was opened and mesitylene was added to the mixture as internal standard for GC analysis. The amounts of diamine and diol were obtained according to calibrated GC results. Yield diamine: 19% (39 mmol); yield diol 18% (37 mmol); turn-over-number according to the diamine: 39.

### Comparative Example 1: Runs 1 to 3 Using Heterogeneous Catalysts

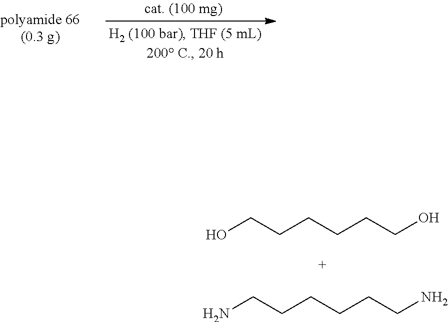 [SMILES: OCCCCCCO ; NCCCCCCN]

Example 1 was repeated except that the ruthenium catalysts as shown in table 2 were used instead of catalyst H. THE was used as the solvent. The autoclave was sealed and flushed with H₂ several times before charging with H₂. Afterwards, the autoclave was put into a preheated aluminum block (200° C.). After the reaction was finished, the autoclave was taken out of the heating block and cooled to r.t. in a water bath. The internal pressure was carefully released. Then, the autoclave was opened and mesitylene was added to the mixture as internal standard for GC analysis. The amounts of diamine and diol were obtained according to calibrated GC results, see table 2.

TABLE 2

| # | catalyst | diamine [mmol] | diol [mmol] |
|---|---|---|---|
| 1 | Ru/C | not detected | not detected |
| 2 | Raney Co | not detected | not detected |
| 3 | Ru@SiO₂ | 0.56 | not detected |

The results in table 2 show that heterogeneous catalysts are not suitable for the hydrogenation of polyamide 66. No hydrogenation occurs in runs 1 and 2. In run 3, only diamine was detected.

### Comparative Example 2: Conversion of 1,6-Hexanediol Using a Heterogeneous Catalyst

A 60 mL Premex autoclave equipped with a Teflon insert was charged with 0.5 mmol 1,6-hexanediol dissolved in 5 mL of THF. 100 mg of the heterogeneous catalyst Ruthenium on silica was added. The autoclave was sealed and flushed with H₂ several times before charging with H₂ (100 bar). Afterwards, the autoclave was put into a preheated aluminum block (200° C.). After the reaction was finished, the autoclave was taken out of the heating block and cooled to r.t. in a water bath. The internal pressure was carefully released. Then, the autoclave was opened and mesitylene was added to the mixture as internal standard for GC analysis. After 29 h, no 1,6-hexanediol was detected. The diol was consumed during the reaction. No reaction product could be identified. Conceivably, 1,6-hexanediol underwent deoxygenation to give hexane.

### Example 3: Conversion of 1,6-Hexanediol Using a Homogeneous Catalyst

Comparative example 2 was repeated except that catalyst Q was used instead of the heterogeneous catalyst. In this experiment, no hydrogenation or deoxygenation of 1,6-hexanediol occurred. This observation underlines the importance of the use of a homogeneous catalyst.

1. A value chain return process for spent polyamides, comprising hydrogenating the spent polyamide in a hydrogen atmosphere in the presence of at least one homogeneous transition metal catalyst complex, wherein the transition metal is selected from metals of groups 7, 8, 9 and 10 of the periodic table of elements according to IUPAC, to obtain a polyamine and a polyol, wherein the hydrogenation is carried out at a reaction temperature of at least 160° C. in a non-reducible solvent having a dipole moment in the range of 1·10⁻³⁰ to 10·10⁻³⁰ C·m.

2. The process according to claim 1, wherein the non-reducible solvent comprises at least one electron pair donor.

3. The process according to claim 1, wherein the non-reducible solvent is selected from ethers, alcohols and amines.

4. The process according to claim 1, wherein the hydrogenation reaction is carried out in the essential absence of DMSO.

5. The process according to claim 1, wherein the reaction temperature is from 170 to 220° C.

6. The process according to claim 1, wherein the spent polyamide is polyamide 66.

7. The process according to claim 1, wherein the homogeneous transition metal catalyst complex comprises a transition metal selected from rhenium, ruthenium, iridium, nickel, palladium or platinum.

8. The process according to claim 1, wherein the homogeneous transition metal catalyst complex comprises at least one polydentate ligand having at least one nitrogen atom and at least one phosphorous atom which are capable of coordinating to the transition metal.

9. The process according to claim 8, wherein the at least one polydentate ligand conforms to general formula (I) 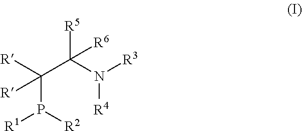
in which
each R′ is independently H or C₁-C₄-alkyl,
R¹ and R², independently of one another, are C₁-C₁₂-alkyl, cycloalkyl or aryl,
which alkyl is unsubstituted or carries 1, 2, 3, 4 or 5 identical or different substituents R⁷, and
which cycloalkyl and aryl are unsubstituted or carry 1, 2, 3, 4 or 5 identical or different substituents R⁸,
R³ and R⁴, independently of one another, are H or C₁-C₁₂-alkyl, which is unsubstituted or carries 1, 2, 3, 4 or 5 identical or different substituents selected from alkoxy, cycloalkoxy, heterocycloalkoxy, aryloxy, hetaryloxy, hydroxyl, NE¹E² and PR¹R²,
R⁵ is H or C₁-C₁₂-alkyl, which is unsubstituted or carries 1, 2, 3, 4 or 5 identical or different substituents R⁷,
R⁶ is H or C₁-C₄-alkyl,
or
R⁴ and R⁶ are absent and R³ and R⁵, together with the nitrogen atom to which R³ is bonded and the carbon atom to which R⁵ is bonded, form a 6-membered heteroaromatic ring,
which is unsubstituted or carries 1, 2, 3, 4 or 5 identical or different substituents which are selected from C₁-C₁₂-alkyl, cycloalkyl, aryl and hetaryl,
which alkyl is unsubstituted or carries 1, 2, 3, 4 or 5 identical or different substituents R⁷, and
which cycloalkyl, aryl and hetaryl are unsubstituted or carry an alkyl substituent which is unsubstituted or carries a substituent selected from alkoxy, cycloalkoxy, heterocycloalkoxy, aryloxy, hetaryloxy, hydroxyl, NE¹E² and PR¹R²,
each R⁷ is independently cycloalkyl, heterocycloalkyl, aryl, hetaryl, alkoxy, cycloalkoxy, heterocycloalkoxy, aryloxy, hetaryloxy, hydroxyl or NE¹E²,
each R⁸ is independently C₁-C₄-alkyl, cycloalkyl, heterocycloalkyl, aryl, hetaryl, alkoxy, cycloalkoxy, heterocycloalkoxy, aryloxy, hetaryloxy, hydroxyl or NE¹E², and
E¹ and E², independently of one another and independently of each occurrence, are radicals selected from H, C₁-C₁₂-alkyl, cycloalkyl and aryl.

10. The process according to claim 9, wherein the at least one polydentate ligand conforms to general formula (II) 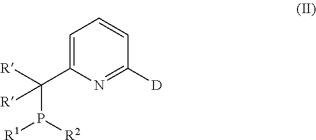
in which
D is H, C₁-C₁₂-alkyl, cycloalkyl, aryl or hetaryl,
which alkyl is unsubstituted or carries 1, 2, 3, 4 or 5 identical or different substituents R⁷, and
cycloalkyl, aryl or hetaryl are unsubstituted or carry an alkyl substituent which is unsubstituted or carries a substituent selected from alkoxy, cycloalkoxy, heterocycloalkoxy, aryloxy, hetaryloxy, hydroxyl, NE¹E² and PR¹R², preferably NE¹E² and PR¹R².

11. The process according to claim 1, wherein the at least one polydentate ligand is selected from compounds A to G, wherein Et is ethyl, iPr is isopropyl, tBu is tert-butyl, Cy is cyclohexyl, Ph is phenyl:

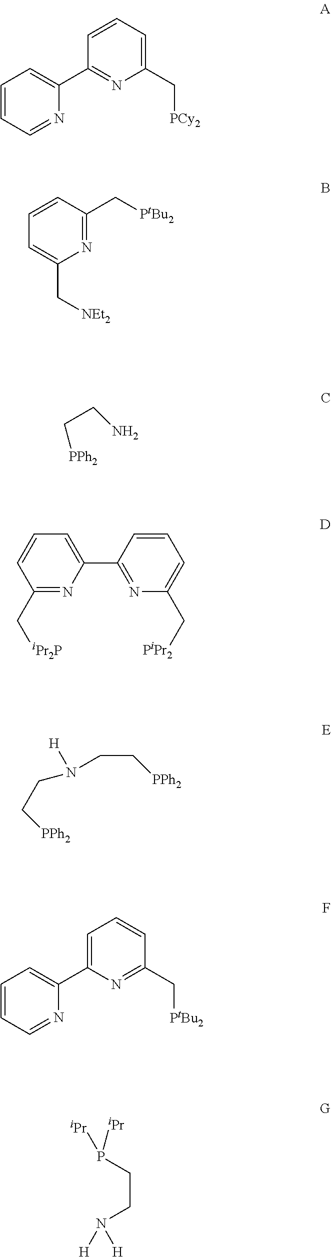

12. The process according to claim 1, wherein the hydrogenation reaction is carried out at a pressure of 50 to 500 bar absolute.

13. The process according to claim 1, wherein the hydrogenation reaction is carried out in the presence of a base.
